(19) United States
(12) Patent Application Publication
(10) Pub. No.: US 2018/0217971 A1
(43) Pub. Date: Aug. 2, 2018

(54) Method and Apparatus for Efficient Creation and Secure Transfer of User Data Including E-Forms

(71) Applicant: Saeid Safavi, San Diego, CA (US)

(72) Inventor: Saeid Safavi, San Diego, CA (US)

(21) Appl. No.: 15/879,922

(22) Filed: Jan. 25, 2018

Related U.S. Application Data
(60) Provisional application No. 62/451,515, filed on Jan. 27, 2017.

(51) Int. Cl. G06F 17/24; H04W 4/80; H04L 29/08; G06K 7/14

(52) U.S. Cl. CPC G06F 17/243; H04W 4/80; G06K 7/1417; G06K 7/1413; H04L 67/06

(57) ABSTRACT

An office communication system for enabling electronic forms to be provided to a potential customer/client (PCC). In some cases, the form is sent from an office system to a PCC device. The form can be completed automatically within the PCC device. The form is then returned by the PCC device to the office system. The information on the form can then in some instances be distributed to remote devices that store the information until requested.

### CROSS-REFERENCE TO RELATED APPLICATIONS—CLAIM OF PRIORITY

This application claims the benefit of priority to provisional Application No. 62/451,515 filed Jan. 27, 2017, entitled “Method and Apparatus for Efficient Creation and Secure Transfer of User Data Including E-Forms”, the disclosure of which is incorporated herein by reference in its entirety.

### FIELD

This disclosure relates to methods and apparatuses for wireless data transfer, data storage, printing services, and applications running on a Potential Customer/Client (PCC) device, such as a mobile device, and more particularly to data extraction inputting, and autofill of business related forms, labels, or other material, in place of hand writing on a paper or to facilitate data entry on PCC devices.

### BACKGROUND

Paper filing of business documentation, forms, etc., can use a significant amount of physical storage space, especially in larger organizations or when accumulated over a long period. Electronic files on the other hand, use little physical space and can be conveniently accessed, reviewed, edited, aggregated, or integrated into different systems in a fast and convenient way.

As the computer industry experiences exponential growth and concurrently electronic storage gets cheaper and cheaper, a majority of businesses and enterprises have switched to electronic filing systems in place of the old file cabinet systems. In addition, businesses that use various enterprise software tools to provide service and enhance their performance, use some form of electronic user data collection and storage to incorporate data into their software tools.

The convenience and efficiency of various new enterprise software platforms is significantly enhanced by the rate of growth in the Internet, networking and wireless communication technologies, which in turn triggers integration of various applications and end-to-end enterprise services. With these advancements enabling various provisioning scenarios, new service models are constantly evolving in home and enterprise to enhance “the user experience”, increase the revenue and enable more efficient business execution.

One sector that is highly impacted by the above advancements in enterprise software platforms is healthcare. In fact, in the US alone, the e-health market has evolved as one of the fastest growing industries. This unprecedented growth can be partially attributed to numerous federal policies and acts that are expected to drive further market development in the near future. This includes the EMR (Electronic Medical Records), EHR (Electronic Health Records), e-prescription, tele-healthcare, and care practice management sectors.

### SUMMARY

This disclosure provides a platform and apparatus for assisting in the filing of e-forms. The disclosed method and apparatus includes methods for: (1) collecting user data; (2) automated and semi-automated form fillings; (3) transferring of user data from a Potential Customer/Client (PCC) Device, such as a mobile device (which may be a phone, tablet, etc.) to an enterprise electronic storage system or to enterprise software; (4) collecting and representing information requested by select businesses in various ways; and (5) providing services to customers or users. The disclosed method and apparatus consists of various embodiments summarized below.

An embodiment of a system including at least a processor and a memory residing on user device includes memory employed for storing instructions configured to instruct the processor to identify different contextual information associated with orchestration of data delivery between a user device and a destination business device over a radio access technology. An ongoing connection may be maintained and reestablished as necessary for control and management purposes.

An embodiment of a method may include algorithms for smart extraction of pre-stored user data that the user desires to fetch from a PCC device (such as a mobile device) or cloud memory and store in various fields of an electronic document, such as e-forms, files, etc. This smart extraction can be direct or facilitated by an ID or code related to a specific target form that needs to be filled.

A system in accordance with one embodiment of the disclosed method and apparatus may include at least a computer readable, Near Field Communication (NFC) device and apparatus that can facilitate transfer of a context aware set of user data between a PCC (such as a user's phone or mobile device) and the enterprise/service provider. Instructions are provided for identifying contextual information associated with sending or receiving special data entry tables, such as e-forms in a medical office or address labels in a post office, as well as, executing certain tasks such as printing or data storage for the purpose of generating a data that facilitates a service (e.g. medical records of a patient or forms and address labels for a package needs to be mailed).

The above NFC mechanism can be enabled by a standalone read/write device, and an NFC platform integrated in another PCC device (such as a mobile phone, a tablet, a computer, or other NFC enabled devices). Alternatively, a barcode or QR code may facilitate the form filling and submission process.

In some embodiments, a “context”, such as a number, code, or an ID, can uniquely identify forms or labels to be filled by a user as requested by a service provider (e.g. doctors office, paramedics, post office, etc.).

In one embodiment, a subset of a patient's profile can be extracted from the user device, by paramedics, or the ER staff, given patient's prior consent. Such a subset can include patient health history, list of allergies, surgeries, and provide the patient's primary care provider's info. This information can be beneficial to emergency treatment.

A cloud server can complement the above NFC mechanism to facilitate data transfer and tasks, such as automated form filling and data storage administrated by the service.

Many other features and embodiments of the invention will be apparent from the accompanying drawings and from the following detailed description.

### BRIEF DESCRIPTION OF DRAWINGS

The accompanying drawings show one or more embodiments; however, the accompanying drawings should not be taken to limit the claimed invention to only the embodiments shown. Various aspects and advantages will become apparent upon review of the following detailed description and upon reference to the following drawings in which:

FIG. 1 is a diagram illustrating an example of a network interaction architecture for a local file exchange service using a Near Field Communication (NFC) device in a medical office and usage of a QR code and a cloud-based platform to complete the form filling and exchange process.

FIG. 1A is a simplified block diagram of the ICC module.

FIG. 2 is a sequence of steps by users, networks, and software components to accommodate the service shown in FIG. 1.

FIG. 3 is a diagram illustrating another example of a network interaction architecture for cloud-based file extraction service and NFC file exchange in a medical office.

FIG. 4 is an example of a sequence of steps by users, networks and software components to accommodate the service in FIG. 3

FIG. 5 is a diagram illustrating an example of a network interaction architecture for cloud-based file exchange service which can be complimented by NFC technology, at a medical office.

FIG. 6 is an example of a sequence of steps by users, networks and software components to accommodate the service in FIG. 5.

### DETAILED DESCRIPTION

As it becomes more prevalent to deployment of various new applications and services in various enterprises, the existing network infrastructure has failed to keep up with the needs of users in various private and public service sectors. It can be seen that enterprises are moving from “service provider centric” to “user centric” architectures, as users gain greater control of the services they receive.

Although the following description uses examples taken from the healthcare industry to provide examples of problems and solutions, healthcare systems are merely one example of an industry to which the disclosed concepts are relevant. The examples and combinations of the examples disclosed also apply to many other use industries and scenarios in which requests are made for some form of manual user input or interaction before service can be provided. Examples include postal service offices, law offices, and financial institutions, to name a few.

EMR (Electronic Medical Record)/EHR (Electronic Health Record) systems have seen an unpresented growth within healthcare industry creating powerful e-Health platforms. This fast growth could be attributed to many factors including the growth in computer software industries, and recent computer networking architectural evolutions, such Software as Service (SaaS), that can run on remote servers on the cloud.

In contrast to such advancement in e-heath platforms, patients (who are a key part of the healthcare proverb service), are still using pen and paper methods from the 20^{th} century to fill in their forms. This manual form filling can use either a manual data entry to the EMR/HER (or other e-Health platforms), by an office associate, or a scanning (and shredding) to have an electronic copy of the paper forms within their e-Health system. This not only consumes significant amount of the patient's time, but also dedicated time from office associate (e.g. medical assistant) to enter the data, and store or shred the paper forms. In addition, patient data entry errors made by a doctor's office or a hospital can have very heavy health costs for that patient, and legal consequences for the care provider.

In one embodiment, usage of the service provider's WLAN network and/or cloud to transfer the office forms to user, and send the filled forms from a Potential Customer/Client (PCC) device (such as a user's mobile device) back to the provider's computer network uses Near Field Communication or NFC technology to facilitate transfer data requested to complete form filling, or other user data entry, between the provider network, cloud and/or the NFC device.

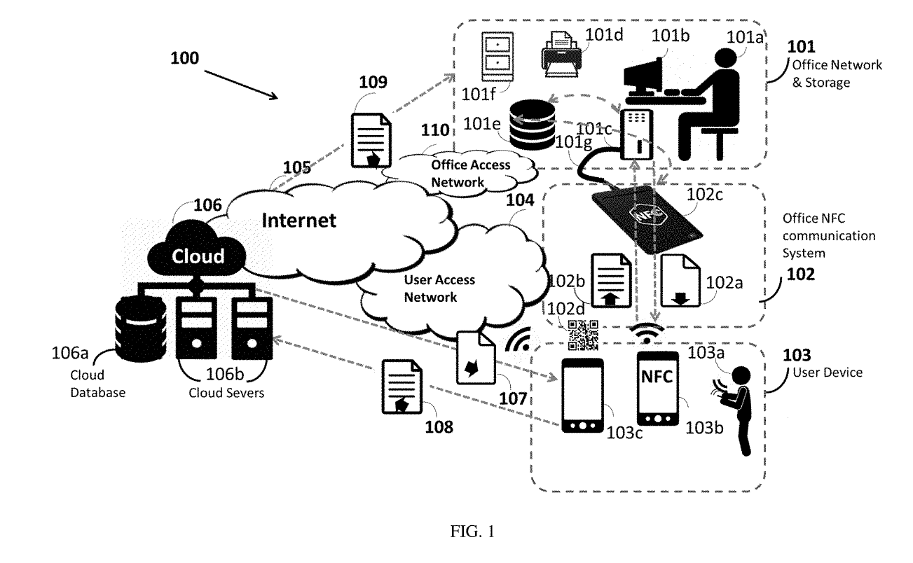

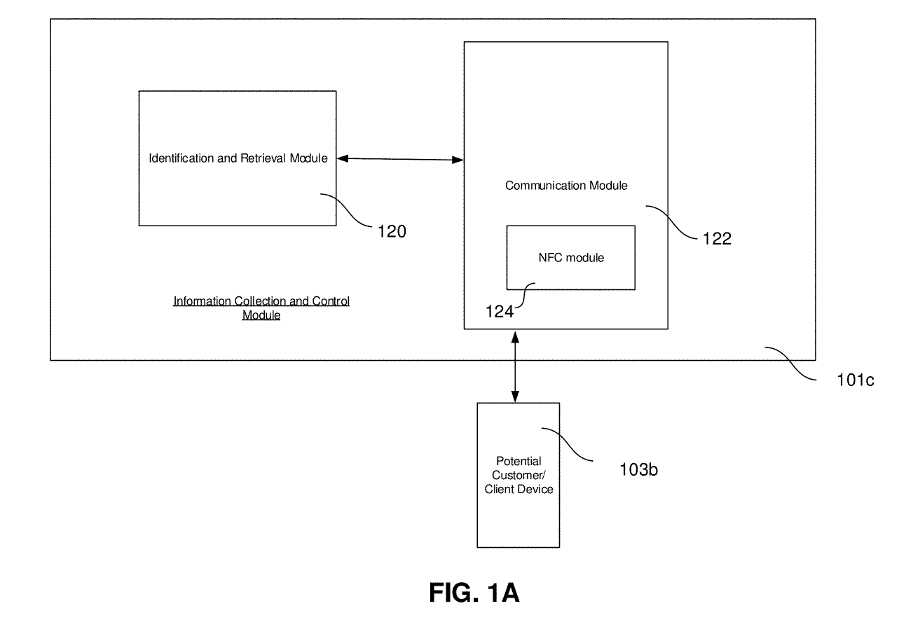

In one embodiment, an NFC device can be directly connected to the healthcare provider's ICC module 101c as shown in FIG. 1. This NFC device is primarily responsible for sending the right e-form or e-forms to the patient, and also, to receive and transfer back the e-form to the healthcare provider computer network (e.g., to the ICC module 101c), after the form is completed or filled. The filled form can be integrated into the provider's EMR or HER system, or alternatively, get stored in a defined location in provider's ICC module 101c, server, or in cloud.

FIG. 1A is a simplified block diagram of the ICC module 101c. Within the ICC module is at least an Identification and Retrieval Module (IRM) 120 and a Communication Module (CM) 122. The CM 122 communicates with the PCC 103b over the NFC through an NFC module 124 within the CM 122. The PCC 103b sends a request over the NFC through the NFC module 124 to the CM 122 for a blank form. The request received by the CM 122 is provided by the CM 122 to the IRM 120. The IRM 120 is responsible for receiving requests from the CM 122 (i.e., from the PCC 103b through the CM 122), retrieving a blank form, and providing the blank form to the CM 122 to send to the PCC 103b in response to the request sent from the PCC 103b. The PCC 103b then completes the form using information stored either locally within the PCC 103b or in a remote storage system, such as in the cloud, etc. The completed form is then transmitted back to the CM 122 within the ICC 101c.

The platform that enables the data exchange for form completion and other tasks in a healthcare provider office or other offices, constitutes of three major components: namely, (1) “The Infrastructure”, which enables device to network connectivity (e.g. WiFi, 3G, LTE) and includes hardware, equipment, and devices used in each use case (such as PCC devices that may in some embodiments be a Mobile device, PC, printer, server, NFC devices); (2) “The Software”; which includes different software constituents designed to enable facilitation of a service running on the infrastructure devices; and (3) “The Algorithms” designed to facilitate the service such as algorithms for matching the user profile data to the forms requested by the enterprise service, algorithms to convert a scanned hard copy of a form to an electronic editable copy, and other algorithms that are relevant to optimization of the said service and may run on device or cloud.

A) The Infrastructure: which includes a combination of networking protocols and data communication media (e.g., Internet, Ethernet, WiFi, Bluetooth, 3G/4G cellular, 60 GHz, etc.), as well as Near Filed Communication (NFC) devices and tools that enables the physical and logical exchange of data between the user device and the business network.

B) The Software: which include “User Device Software” component or “UDS” (e.g. Android application, Windows/Mac application, iOS application and/or middleware), The “Business Network Software” component or “BNS” (including the business application software and software for storage mechanisms such as local data bases, caches, etc.), and the “Cloud Sever Software” component or “CSS” (e.g. massive data bases and parallel processing; like Hadoop, Cassandra; data retrieval and processing mechanism; such as HIVE, MapReduce, and SQOOP; and an “Analytics Engine” or (AE)).

C) Algorithms: which include the algorithms running in the said Analytics Engine (AE) such as different types of Machine Learning (ML) algorithms, and may include some algorithms running both on the business network, cloud, and the user device components. For example, this includes algorithms that scan a hard copy of a form and convert it to an interactive form that can be filled electronically on user device, or algorithms that can automatically retrieve user information and autofill the electronic forms. These algorithms run on the cloud analytics engine and/or locally on a PCC device or the ICC module 101c, or a business network computer/server

Initial Data Entry: In one embodiment, it is assumed that once the patient (PCC device user) downloads the UDS application, he or she gets prompted to enter all of his/her available demographics and health-related (or other) Information once on his device, to be stored on his PCC device and/or the cloud through the CSS software cloud. Alternatively, the user can enter his/her information directly on the cloud. Once this information is stored, it can be used as a superset data, to assist with automated form filling process taking place in the PCC device or the cloud. We call this superset data and the user's e-Form Database of eFDB.

The Autofill Process: Once a new form is downloaded to the user device and in some cases in the cloud, the autofill software algorithm that can run on a PCC device (i.e., user's mobile device) or on the cloud, reads the existing fields of the downloaded form and records them in a location. Then using an algorithm, it searches the fields of eFDB for the same fields and once each field is fund, the data in that field is fetched and loaded onto the analogous new form's field. This process continues until all of the fields of the new e-form are filled, or some of the fields cannot be found in the eFDB.

User Review and Signing: In one embodiment, after completion of the autofill process for the new download form, the user is prompted to review the form and approve its transmission. In a case where some fields are left bank, after the autofill, the user/patient get promoted (by the UDS App or CSS Software), to fill in the remaining filed by typing on a PCC device (i.e., the user/patient's mobile device), sign the form either by e-signature or by signing with finger, or confirm that the form can be sent as is.

e-Form Transfer: In one embodiment, after the user approves transmission of the form the filled e-form gets transferred to the healthcare provider or other third party institutions, such as a health insurance provider, within HIPAA guidelines. This can be done directly using NFC technology, where the patient/user places his/her phone on an NFC read device connected to care provider network, resulting in a direct ultra secure file transfer (without going over Internet), or by pushing back the form back to the cloud, on the care provider's web application, or EMR/HER system, which can be accessed by the administrative staff and the doctor or nurse at the care provider's office.

FIG. 1 shows a system comprising both an NFC enabled user device/phone and a non-NFC enabled user device. A user electronically fills in the forms requested by a business, through its local proximity to the said business office and its network through the Near Field Communication (NFC) technology.

The block 101 illustrates an example of the system components and storage mechanisms. The system comprises a monitor 101b, an Information Collection and Control (ICC) module 101c, a printer 101d, and filing cabinet 101f. A data storage device is shown in 101e which could be in form of a memory coupled to the processor, wherein the memory comprises instructions that cause the processor to send the data from the ICC module 101c to the memory. 101a shows an office's administrative personnel that interacts with BNS for the said data transaction.

In an embodiment, the data storage device 101e may comprise a read only memory (ROM), a random access memory (RAM), a flash memory, an external memory (e.g., a secure digital (SD) card), or any suitable type of memory device as would be appreciated by one of ordinary skill in the art upon viewing this disclosure, or combinations thereof.

In another embodiment, the data storage device 101e may comprise a disk drive, a tape drive, or any suitable type of memory device as would be appreciated by one of ordinary skill in the art upon viewing this disclosure, or combinations thereof.

As shown in FIG. 1, the office has installed an NFC read/write device 102c which is connected to its ICC module 101c over the office network. By putting patient's NFC enabled Potential Customer/Client (PCC) device 103b, such as a mobile device that in some embodiments may be a mobile phone, in close proximity of the NFC read/write device, an NFC link is automatically established. This connectivity enables the blank form or forms 102a to be downloaded from the network 101. The form 102b is then filled in. The form is then uploaded by the NFC enabled PCC device 103b. It is noted that all or part of the information requested by the form 102a can be filled in by the user 103a, auto-filled by a component of UDS, or a combination of the two, as described above.

FIG. 1 also shows a use case wherein the patients device/phone 103c is not NFC enabled. In this case, the patient uses a QR code reader (or barcode reader) to connect to a URL that stores the desired blank e-form 107. The stored e-form is then downloaded to the user's PCC device.

After the new e-form is downloaded to the user's PCC device, by either NFC or Internet, the UDS application initiates the autofill process, by searching, matching, and filling the new form, by searching through the eFDB database stored in the patient's phone or PCC device. After the autofill is completed, the “User Review and Signing” steps follow, and the form gets ready to be transferred back to the care provider's network.

As shown in FIG. 1, this can be done by the NFC enabled user device 103, to send the completed e-form 102b, back to the provider's network and storage system 101. Alternatively, the Non-NFC enabled user device 103c, upload the filled e-form 108 through the user access network (e.g. WiFi, 3G, and 4G cellular) to the Internet and the cloud database 106a, managed by CSS. This database and the file can then be accessed by the care provider office either directly through filled e-form 109, or by integration with the EMR/HER system being used by the provider office.

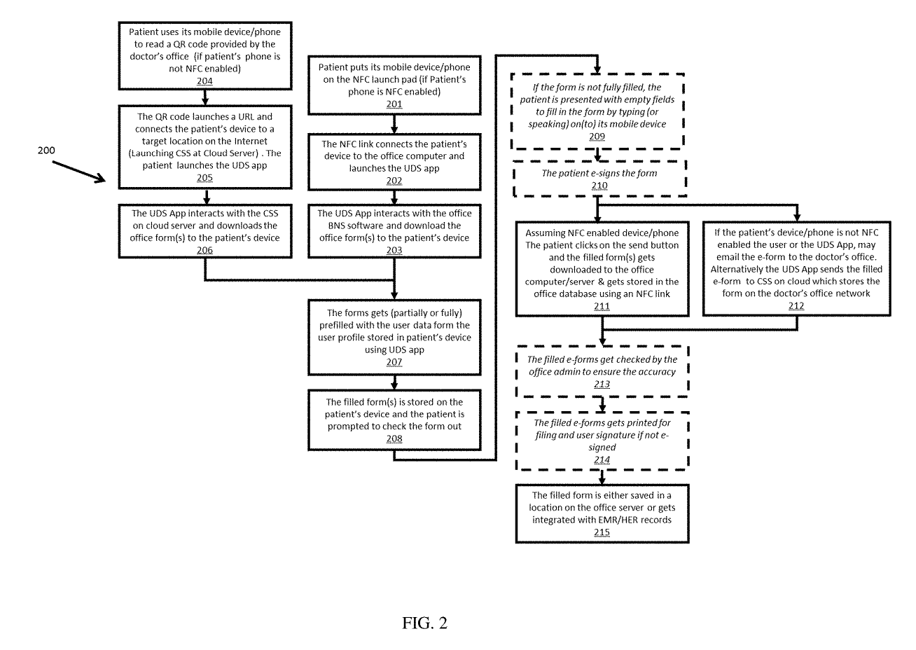

FIG. 2 illustrates an example of the steps for the connectivity scenario of the FIG. 1. It is noted that the steps described herein may vary according to the service, user, and network requirements. Accordingly, the mentioned steps are solely provided as an example. The figure shows both NFC enable and non-NFC user device scenarios. In particular, steps 201 through 203 describe the user actions and interaction of the software components to directly download the e-form or e-forms from doctor's office to the patient/user's PCC device. On the other hand, steps 204 through 206, describe an alternative approach to download e-form(s) to the user device using a QR code and Internet link to a specific URL that stores the form(s), managed by CSS.

Once the form gets download to the PCC device, the autofill process using queries to the eFDB gets started (steps 207 and 208). After completion, the arbitrary steps of 209 and 210 cover ensures that to patient/user reviews, complete filling of the form if needed, and e-signs the form(s).

In step 211 the completed e-form(s) is transferred back to the care provider's office network using the NFC technology, by putting the user's device on the NFC read/write pad, connected to the provider's network. Step 212, describes the same transfer, using internet and cloud-based software.

Finally, arbitrary steps 213 and 214, gives the provider's office an opportunity to review and determine whether a printed signature is needed, print the form, while step 2015 completes the form transfer and storage into the provider's network or its EMR/EHR. It is noted that if case of cloud-based e-Health system, the filled form may be to be transferred back to the cloud, to get integrated with EMR/EHR, or a web application that maintains user/patient profiles. It is noted that in FIG. 2 the boxes with dashed borders and italic text are considered as optional.

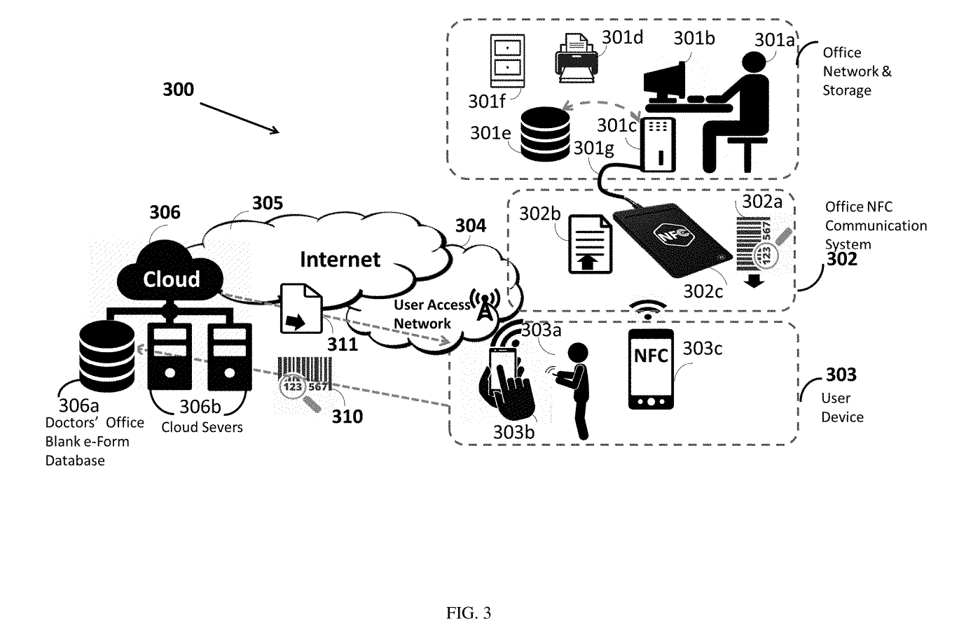

FIG. 3 depicts another example of a scenario wherein the interaction of user device with different networks and software component electronically fills in the forms requested by the doctor's/care provider's office.

In the example, an NFC read/write device called NFC launch pad 302c, is connected to the provider's network 301, in a setup similar to FIG. 1. However, unlike FIG. 1, the e-from is not directly downloaded to the users NFC enabled device 303c. Instead, a code, a barcode, or QR code 302a which uniquely identifies the requested form(s) is transferred to the user's device 303c, using NFC technology. In some embodiments, the patient puts its device on the NFC launch pad to establish the NFC link.

The above code 302a is received by the UDS application and through user's device access network (e.g. WiFi, Cellular) is transferred to the Internet to a cloud location, wherein a web application managed by CSS, reads it into a file and translate the code to search and fetch the appropriate e-form(s) it stores in a database called “Doctors' Office Blank e-Form Database”, 306a. The CSS then transfers the fetched form 311 through internet, back to the user's device that is received and processed by UDS application. Alternatively, the barcode can be read directly by a camera in the UDS. A barcode reader application may then interpret the image to attain data that gets loaded into a blank form.

It is noted that the file containing the code for blank form(s) 302a may, or may not be further processed by the UDS application, based on the need for preparation of the code for the right format for the cloud web application. As such, the code 310 can have different representation format or value, compared to 302a.

Once the blank e-from 311 is received by user device, it will be processed by the UDS, and go through the autofill process using the eFDB database as described above. Once the form is filled and ready to transfer to the provider's ICC module 101c, the user/patient uses the NFC launch pad to transmit the completed form 302b, back to the provider's network for storage or integration in EMR/EHR.

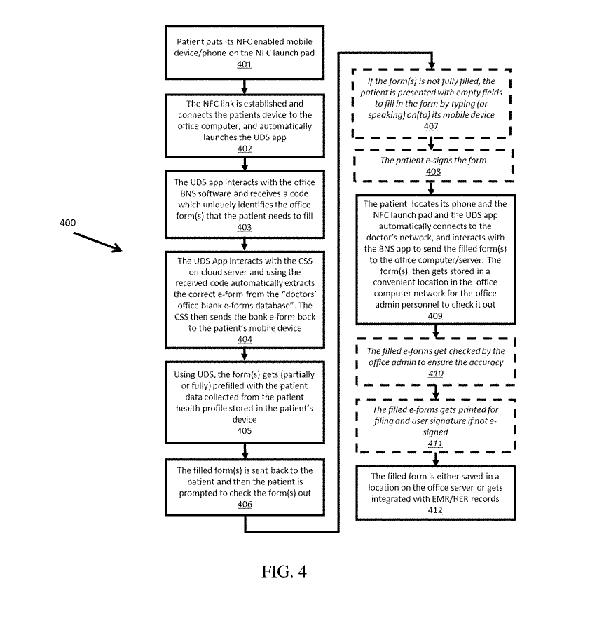

FIG. 4 illustrates the steps used for the connectivity and data exchange scenario of the FIG. 3 to take place. It is noted that the steps described herein may warry according to the service, user, and network requirements and the mentioned steps are solely as an example.

First, the patient starts the e-form transfer process from care provider's network to his/her PCC device/phone by placing it on the NFC launch pad. Through the interaction between UDS office software BNS the UDS receives a code in specific form such as a number, a bar code, or a QR code in step 403. During step 404, the UDS app interacts with the CSS in cloud to send the code to a location include, wherein a web app can transfer the code to an address for extraction of the e-form(s) requested by the doctor's office. As mentioned prior to transfer to the web application, the UDS may postprocess the number or change its format.

The steps 405 through 408, is similar to steps 207 through 210, in FIG. 2, leading to preparation of the e-forms for transfer to the care provider's network. Step 409, describes the sequence of actions and software infraction between UDS and BNS to get the form ready for administrative staff's final review. The optional steps 410 and 411 cover this, and collection patient's signature(s) if needed. Finally, in Step 412 the completed form gets stored in the care provider's system.

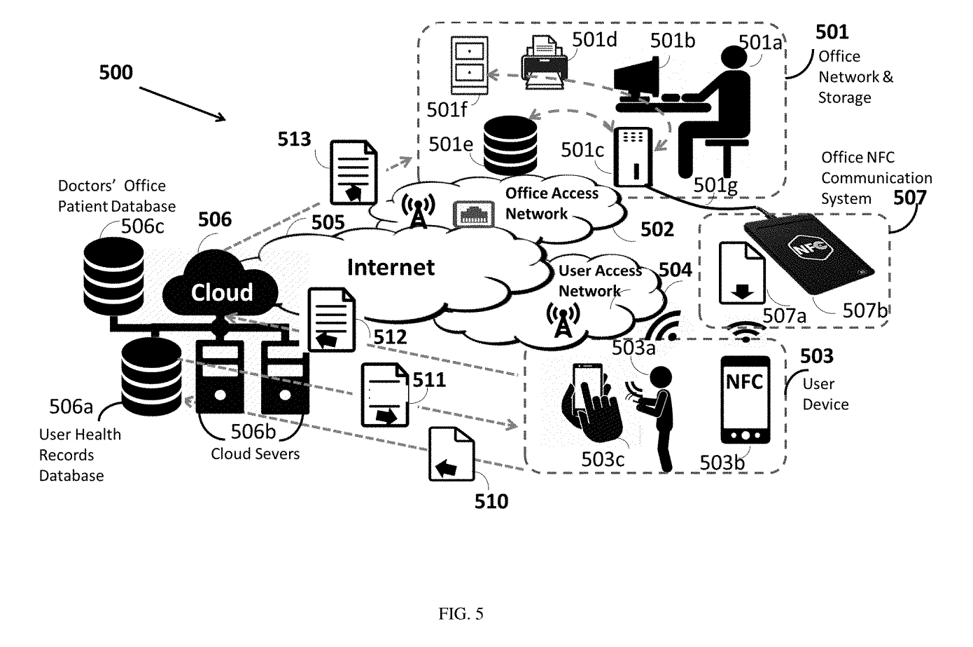

FIG. 5 depicts a networking scenario wherein the processes of e-form autofill and transfer of e-form to the health care provider network are performed on cloud. In this case the NFC technology is used for download of the new blank form 507a from the healthcare provider's office.

More specifically, similar to the scenario in FIG. 1, the office has installed an NFC read/write device 507b which is capable of transferring blank form(s) to the user's PCC device (e.g., phone). By putting patient's NFC enabled PCC device 503b (such as a mobile phone) and through a process involved BNS and UDS software, the blank form or forms 507a will be downloaded from the network 501, to the user device 503c.

In the next step the user sends the bank form, to the correct cloud location in cloud, wherein using CSS the form gets auto-filled by accessing a cloud-based eFDB that maintains all of the patient's health and demographic related information, called User Health Records Database 506a.

It is assumed that the database 506a, has been established earlier on through interaction of UDS with the user, to fill the super data for eFDB and then through interaction with CSS, the UDS sends the data to the cloud to be stored in 506a.

Alternatively, in another embodiment, the eFDB can be established by a web application managed by CSS, so that the patient fills all of the content of eFDB in an online method, with the engagement of UDS.

Once the blank form gets auto filled in cloud it (511) is sent back to the user's PCC device to fill any ramming blank fields and/or e-sign the form if needed. After user's approval the completed form 512 gets back to the cloud to be stored in “Doctors' Office Patient Database” 506c. and or the doctor's cloud-based EMR/HER system.

Finally, the filled form 513 can be accessed for different purposes by the office admin or the Doctor/Nurse immediately after it is storage in 506c.

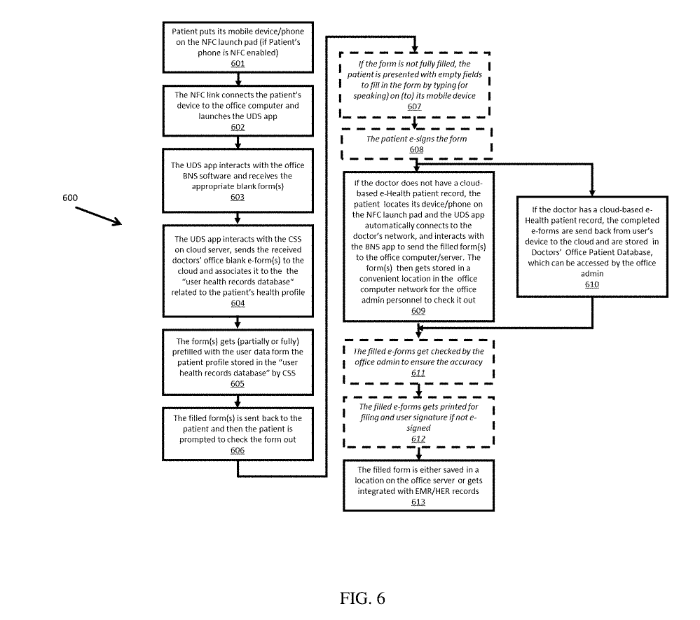

FIG. 6 shows the steps used for the connectivity and data exchange scenario of the FIG. 5. The process assumes that the user's device/phone is NFC enabled. Steps 601 through 603 illustrate the new e-form download processes to the user's device, while steps 604 through 608 give examples of the steps used to autofill the form(s) in the cloud and send it back to the user for completion of the filling process.

Steps 609 and 610 consider the cases where the doctor's office has a local e-health system and when the doctor's office has a cloud-based e-health system, respectively. In 609, the BNC and UDS app work closes to establish transfer of the completed e-From to the doctor's office network, using Internet and the user and office access networks as described in FIG. 5 technology. In case of 610, the e-forms is integrated into the Doctor's cloud-based e-heath system.

Finally, as mentioned before, steps 611 through 613 complete the e-form

It is noted that the steps described herein may warry according to the type of care provider's network setup, user device, the access network requirements, the implementation of applications and software, as well as, the Internet and cloud-based infrastructure. As such, the mentioned steps are solely for as an example and any feasible combination of the above steps may be exercised based on the use case and user/service provider preferences.

What is claimed is:

1. An Information Collection and Control (ICC) module comprising:
a) a form identification and retrieval module configured to receive a request and identify which form, from among a plurality of possible forms, has been requested and to retrieve the requested form in response to the received request; and
b) a communication module having an Near Field Communication (NFC) sub-module and configured to:
i. receive through the NFC sub-module, a request from a potential customer/client (PCC);
ii. provide the request to the form identification and retrieval module, the communication module being coupled to the form identification and retrieval module;
iii. receive a completed form from the identification and retrieval module; and
iv. transmit the completed form to the requesting PCC; and
c) A barcode/QR code reading platform that can translate the code to a form so that an autofill process can fully or partially fill in the form.
